(19) United States
(12) Patent Application Publication
(10) Pub. No.: US 2023/0075675 A1
(43) Pub. Date: Mar. 9, 2023

(54) Flat Fuel Cell Device

(71) Applicants: Hyundai Motor Company, Seoul (KR); Kia Corporation, Seoul (KR)

(72) Inventors: Su Ji Kim, Seoul (KR); Joung Ho Lee, Seongnam-si (KR); Yong Lip Kim, Seongnam-si (KR)

(21) Appl. No.: 17/847,357

(22) Filed: Jun. 23, 2022

(30) Foreign Application Priority Data
Sep. 3, 2021 (KR) 10-2021-0117387

(51) Int. Cl. H01M 8/04111; H01M 8/04029

(52) U.S. Cl. CPC H01M 8/04111; H01M 8/04029; H01M 2250/20

(57) ABSTRACT

An embodiment flat fuel cell device includes a fuel cell comprising a cell stack in which a plurality of unit cells is stacked, a junction box electrically connected to the fuel cell, an air-processing device configured to manage inflow and outflow of air containing oxygen between an outside and the fuel cell, and a hydrogen-processing device configured to manage inflow and outflow of hydrogen to and from the fuel cell. Each of the junction box, the air-processing device, and the hydrogen-processing device is disposed so as to be contiguous with the fuel cell in a horizontal direction.

### CROSS-REFERENCE TO RELATED APPLICATIONS

This application claims the benefit of Korean Patent Application No. 10-2021-0117387, filed on Sep. 3, 2021, which application is hereby incorporated herein by reference.

### TECHNICAL FIELD

Embodiments relate to a flat fuel cell device.

### BACKGROUND

In general, fuel cell devices have been developed for the purpose of being mounted in vehicles such as passenger cars or commercial vehicles. Therefore, fuel cell devices have a configuration (or layout) having relatively few height constraints. These days, however, fuel cell devices are being increasingly used in various products other than vehicles in order to meet various needs of customers. In particular, when a fuel cell device is mounted in a product such as a tram, an aircraft, or a drone, the height of the fuel cell device needs to be low. For this reason, a general fuel cell device for a vehicle is incapable of being used therefor. Therefore, research for solving this problem is underway.

### SUMMARY

Accordingly, embodiments are directed to a flat fuel cell device that substantially obviates one or more problems due to limitations and disadvantages of the related art.

Embodiments provide a flat fuel cell device having a low height.

However, the objects to be accomplished by the embodiments are not limited to the above-mentioned objects, and other objects not mentioned herein will be clearly understood by those skilled in the art from the following description.

A flat fuel cell device according to an embodiment may include a fuel cell including a cell stack in which a plurality of unit cells is stacked, a junction box electrically connected to the fuel cell, an air-processing unit configured to manage inflow and outflow of air containing oxygen between the outside and the fuel cell, and a hydrogen-processing unit configured to manage inflow and outflow of hydrogen to and from the fuel cell. Each of the junction box, the air-processing unit, and the hydrogen-processing unit may be disposed so as to be contiguous with the fuel cell in a horizontal direction.

For example, the flat fuel cell device may further include a cooling-medium-processing unit configured to manage inflow and outflow of a cooling medium to and from the fuel cell. The cooling-medium-processing unit may be disposed so as to be contiguous with the fuel cell in the horizontal direction.

For example, at least one of at least a portion of the hydrogen-processing unit or at least a portion of the air-processing unit maybe disposed in a side area. The side area may include at least one of a right area overlapping the right side of the fuel cell so as to be contiguous therewith in a first direction, which is one of the horizontal directions, a left area overlapping the left side of the fuel cell so as to be contiguous therewith in the first direction, a right extension area extending from the right area in a second direction, which is another one of the horizontal directions and intersects the first direction, or a left extension area extending from the left area in the second direction.

For example, the hydrogen-processing unit may be disposed in at least one of the right area or the right extension area, and the cooling-medium-processing unit may be disposed in at least one of the left area or the left extension area.

For example, the hydrogen-processing unit may be disposed in at least one of the left area or the left extension area, and the cooling-medium-processing unit may be disposed in at least one of the right area or the right extension area.

For example, the air-processing unit may include an air compressor configured to suction air from the outside and to discharge the air, a moisture controller configured to humidify the air discharged from the air compressor and to discharge the humidified air and configured to dehumidify oxygen as a reactant gas discharged from the fuel cell and to discharge the dehumidified oxygen, an air cut-off valve configured to provide the humidified air to the fuel cell and to provide the oxygen as the reactant gas discharged from the fuel cell to the moisture controller, and a discharge unit configured to discharge the oxygen as the reactant gas passing through the moisture controller to the outside.

For example, the air-processing unit may be disposed in a front area. The front area may include at least one of a front side area overlapping the front side of the fuel cell so as to be contiguous therewith in a second direction, which is one of the horizontal directions, or a front extension area extending from the front side area in a first direction, which is another one of the horizontal directions and intersects the second direction, and in which the plurality of unit cells is stacked.

For example, the air-processing unit may further include an additional manifold interconnecting the air cut-off valve and the fuel cell.

For example, the junction box maybe disposed in a rear area. The rear area may include at least one of a rear side area overlapping the rear side of the fuel cell so as to be contiguous therewith in the second direction, or a rear extension area extending from the rear side area in the first direction.

For example, the air cut-off valve may include a first opening/closing portion configured to selectively discharge the air discharged from the moisture controller to the fuel cell in the horizontal direction, and a second opening/closing portion configured to selectively discharge the oxygen as the reactant gas discharged from the fuel cell to the moisture controller in the horizontal direction.

For example, the discharge unit may include an exhaust duct configured to form a path through which the reactant gas output from the moisture controller passes, and an exhaust hose configured to discharge the reactant gas passing through the exhaust duct to the outside.

For example, the exhaust hose may have a multi-pipe structure.

For example, the hydrogen-processing unit may include a blower configured to suction and discharge hydrogen as a reactant gas and condensate water, a fluid classifier configured to separate the hydrogen and the condensate water discharged from the blower, an ejector configured to supply the hydrogen separated by the fluid classifier to the fuel cell, and a drain/purge valve connected to the exhaust duct in order to discharge the condensate water and the hydrogen as the reactant gas separated by the fluid classifier.

For example, the hydrogen-processing unit may further include a partition wall configured to separate an inlet and an outlet of the blower from each other.

For example, an outlet of the fuel cell, via which hydrogen as the reactant gas is discharged, may be located at a higher position than the drain/purge valve from the ground.

For example, the cooling-medium-processing unit may include an inlet into which the cooling medium is introduced, and an outlet from which the cooling medium is discharged. The inlet and the outlet may be oriented toward the front area.

For example, the flat fuel cell device may further include a system frame to which the fuel cell and the junction box are mounted.

A flat fuel cell device according to another embodiment may include a fuel cell including a cell stack in which a plurality of unit cells is stacked, a junction box electrically connected to the fuel cell, an air-processing unit configured to manage inflow and outflow of air containing oxygen between the outside and the fuel cell, and a hydrogen-processing unit configured to manage inflow and outflow of hydrogen to and from the fuel cell. The fuel cell may have a planar shape that is surrounded by the junction box, the air-processing unit, and the hydrogen-processing unit in a horizontal direction.

For example, the flat fuel cell device may further include a cooling-medium-processing unit configured to manage inflow and outflow of a cooling medium to and from the fuel cell. The fuel cell may have a planar shape that is surrounded by the junction box, the air-processing unit, the hydrogen-processing unit, and the cooling-medium-processing unit in the horizontal direction. The fuel cell, the junction box, the air-processing unit, the hydrogen-processing unit, and the cooling-medium-processing unit may not overlap each other in a vertical direction.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a plan view for explaining a peripheral area of a fuel cell in a flat fuel cell device according to an embodiment;

FIGS. 2A and 2B are, respectively, a front perspective view and a rear perspective view of an embodiment of the fuel cell shown in FIG. 1;

FIG. 3 is a plan view of an embodiment of the flat fuel cell device shown in FIG. 1;

FIG. 4 is a plan view of another embodiment of the flat fuel cell device shown in FIG. 1;

FIG. 5 is a block diagram of an embodiment of an air-processing unit;

FIG. 6 is a perspective view of an embodiment of the air cut-off valve shown in FIG. 5;

FIGS. 7A and 7B are cross-sectional views for explaining the operation of the air cut-off valve shown in FIG. 6;

FIG. 8 is a perspective view showing the external appearance of an embodiment of the air-processing unit shown in FIG. 5;

FIG. 9 is a view showing the configuration of an embodiment of a hydrogen-processing unit;

FIG. 10 is a perspective view showing the external appearance of an embodiment of the flat fuel cell device shown in FIG. 3;

FIG. 11 is a plan view of a fuel cell vehicle including a flat fuel cell device according to still another embodiment;

FIG. 12 is a left-side view of the flat fuel cell device shown in FIG. 11;

FIG. 13 is a right-side view of the flat fuel cell device according to an embodiment;

FIG. 14 is a schematic cross-sectional view of a fuel cell device according to a comparative example;

FIG. 15 is a perspective view of an air cut-off valve included in an air-processing unit according to the comparative example; and

FIGS. 16A and 16B are cross-sectional views for explaining the operation of the air cut-off valve shown in FIG. 15.

### DETAILED DESCRIPTION OF ILLUSTRATIVE EMBODIMENTS

The present disclosure will now be described more fully hereinafter with reference to the accompanying drawings, in which various embodiments are shown. The examples, however, may be embodied in many different forms, and should not be construed as being limited to the embodiments set forth herein. Rather, these embodiments are provided so that this disclosure will be more thorough and complete, and will more fully convey the scope of the disclosure to those skilled in the art.

It will be understood that when an element is referred to as being “on” or “under” another element, it may be directly on/under the element, or one or more intervening elements may also be present.

When an element is referred to as being “on” or “under”, “under the element” as well as “on the element” may be included based on the element.

In addition, relational terms, such as “first”, “second”, “on/upper part/above” and “under/lower part/below”, are used only to distinguish between one subject or element and another subject or element, without necessarily requiring or involving any physical or logical relationship or sequence between the subjects or elements.

Hereinafter, a flat fuel cell device according to an embodiment will be described with reference to the accompanying drawings. Here, the flat fuel cell device (or full flat fuel cell device) may refer to a fuel cell device having a low height (or a small thickness). For example, the flat fuel cell device may have a lower height than a fuel cell device for a vehicle, which has few height constraints.

The flat fuel cell device will be described using the Cartesian coordinate system (x-axis, y-axis, z-axis) for convenience of description, but may also be described using other coordinate systems. In the Cartesian coordinate system, the x-axis, the y-axis, and the z-axis are perpendicular to each other, but the embodiments are not limited thereto. That is, the x-axis, the y-axis, and the z-axis may intersect each other obliquely. For convenience of description, the y-axis direction will be referred to as a “first direction”, the x-axis direction will be referred to as a “second direction”, and the z-axis direction will be referred to as a “third direction”.

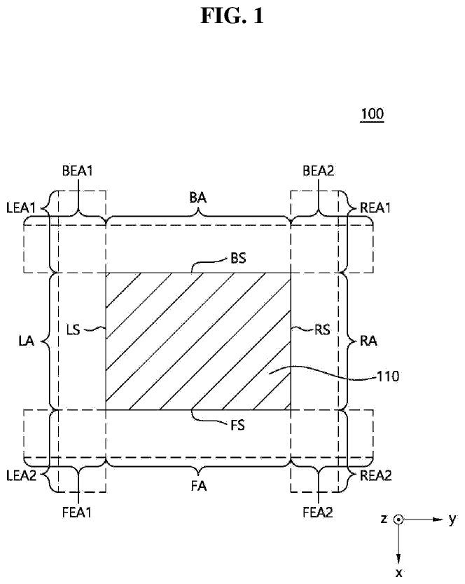

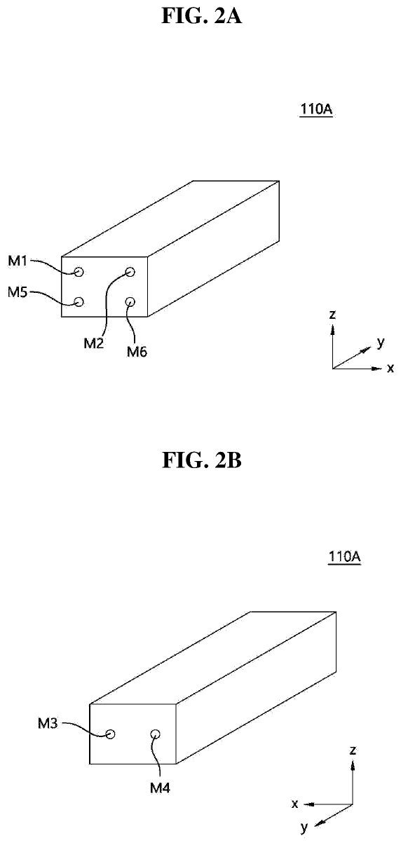

Prior to describing the flat fuel cell device 100 according to the embodiments, a peripheral area of a fuel cell 110 included in the flat fuel cell device 100 and the fuel cell 110 will now be described with reference to FIGS. 1, 2A, and 2B.

FIG. 1 is a plan view for explaining the peripheral area of the fuel cell 110 in the flat fuel cell device 100 according to an embodiment.

The peripheral area may refer to an area in the vicinity of the fuel cell 110, and is defined as an area that is contiguous with or adjacent to the fuel cell 110 in at least one direction (hereinafter referred to as a “horizontal direction”) among the first direction (i.e., the y-axis direction) or the second direction (i.e., the x-axis direction), and does not overlap the fuel cell 110 in the third direction (i.e., the z-axis direction) (hereinafter referred to as a “vertical direction”). The peripheral area may include at least one of a side area, a front area, and a rear area. Here, the horizontal direction may refer to the width direction of the flat fuel cell device 100, and the vertical direction may refer to the height direction or the thickness direction of the flat fuel cell device 100.

The side area may include at least one of a right area RA, a first right extension area REA1, a second right extension area REA2, a left area LA, a first left extension area LEA1, or a second left extension area LEA2.

The right area RA is defined as an area that overlaps the right side RS of the fuel cell 110 so as to be contiguous therewith, in the first direction, which is one of the horizontal directions. In addition, the first and second right extension areas REA1 and REA2 are defined as areas that extend from the right area RA in the second direction, which intersects the first direction and is another one of the horizontal directions.

The left area LA is defined as an area that overlaps the left side LS of the fuel cell 110 so as to be contiguous therewith, in the first direction. The first and second left extension areas LEA1 and LEA2 are defined as areas that extend from the left area LA in the second direction.

The front area may include at least one of a front side area FA, a first front side extension area FEA1, or a second front side extension area FEA2.

The front side area FA is defined as an area that overlaps the front side FS of the fuel cell 110 so as to be contiguous therewith, in the second direction. The first and second front side extension areas FEA1 and FEA2 are defined as areas that extend from the front side area FA in the first direction.

The rear area may include at least one of a rear side area BA, a first rear side extension area BEA1, or a second rear side extension area BEA2.

The rear side area BA is defined as an area that overlaps the rear side BS of the fuel cell 110 so as to be contiguous therewith, in the second direction. The first and second rear side extension areas BEA1 and BEA2 are defined as areas that extend from the rear side area BA in the first direction.

FIGS. 2A and 2B are, respectively, a front perspective view and a rear perspective view of an embodiment 110A of the fuel cell 110 shown in FIG. 1.

The fuel cell 110 according to the embodiment may include a unit fuel cell, which is not stacked either in the vertical direction or in the horizontal direction.

Alternatively, a fuel cell 110 according to another embodiment may include a plurality of unit fuel cells, which are stacked in at least one of the vertical direction or the horizontal direction. For example, the fuel cell 110 may include a plurality of unit fuel cells, which are stacked in at least one of the x-axis direction, the y-axis direction, or the z-axis direction.

Hereinafter, the fuel cell 110 of the flat fuel cell device 100 according to an embodiment will be described as including a single unit fuel cell 110A. However, the following description may also apply to the case in which the fuel cell 110 of the flat fuel cell device 100 according to an embodiment includes a plurality of unit fuel cells.

The unit fuel cell may be a polymer electrolyte membrane fuel cell (or a proton exchange membrane fuel cell) (PEMFC), which has been studied most extensively as a power source. However, the embodiments are not limited to any specific configuration or external appearance of the unit fuel cell.

The unit fuel cell 110A included in the fuel cell 110 may include end plates (or pressing plates or compression plates) (not shown), current collectors (not shown), and a cell stack (not shown).

The cell stack may include a plurality of unit cells, which are stacked in the first direction. Several tens to several hundreds of unit cells, e.g., 100 to 400 unit cells, maybe stacked to form the cell stack. The number of unit fuel cells 110A included in the fuel cell 110 and the number of unit cells included in the cell stack of the unit fuel cell 110A may be determined in accordance with the intensity of the power to be supplied from the unit fuel cell 110A to a load. Here, “load” may refer to a part that requires the power of the fuel cell 110.

The end plates maybe disposed at respective ends of the cell stack, and may support and fix the plurality of unit cells. That is, the first end plate may be disposed at one of the two ends of the cell stack, and the second end plate may be disposed at the other one of the two ends of the cell stack.

In addition, the fuel cell 110 may further include a clamping member. For example, in the unit fuel cell 110A, the clamping member serves to clamp a plurality of unit cells together with the end plates in the first direction. The clamping member may be implemented as a clamping bar (not shown) or an enclosure (not shown).

The unit fuel cell 110A shown in FIGS. 2A and 2B may include first to sixth manifolds M1 to M6.

The first and second manifolds M1 and M2 may be gas inflow manifolds (or gas inlet manifolds), through which reactant gases are introduced into the cell stack from the outside of the unit fuel cell 110. For example, hydrogen, which is a reactant gas, may be introduced into the cell stack from the outside through one of the first and second manifolds M1 and M2, and air containing oxygen may be introduced into the cell stack from the outside through the other one of the first and second manifolds M1 and M2.

One of the third and fourth manifolds M3 and M4 maybe a cooling medium inflow manifold (or a cooling medium inlet manifold), through which a cooling medium (e.g., coolant) is introduced into the unit fuel cell 110 from the outside in order to maintain the temperature of the cell stack, and the other one of the third and fourth manifolds M3 and M4 may be a cooling medium outflow manifold (or a cooling medium outlet manifold), through which the cooling medium is discharged from the unit fuel cell 110A to the outside.

The fifth and sixth manifolds M5 and M6 may be gas outflow manifolds (or gas outlet manifolds), through which the reactant gases that have been completely used in the cell stack and condensate water (or product water), which is a byproduct, are discharged to the outside of the cell stack. For example, hydrogen, which is the reactant gas, may be discharged to the outside of the cell stack together with the condensate water through one of the fifth and sixth manifolds M5 and M6, and oxygen, which is the reactant gas, may be discharged to the outside of the cell stack together with the condensate water through the other one of the fifth and sixth manifolds M5 and M6.

In this case, the gas outflow manifolds M5 and M6 may be disposed below the gas inflow manifolds M1 and M2.

Further, the gas inflow manifold and the gas outflow manifold, through which the same reactant gas is introduced and discharged, maybe disposed so as to be spaced apart from each other in the diagonal direction. For example, in the case in which air containing oxygen is introduced through the first manifold M1, the oxygen and condensate water may be discharged through the sixth manifold M6, which is disposed so as to be spaced apart from the first manifold M1 in the diagonal direction. Also, in the case in which hydrogen, which is the reactant gas, is introduced into the second manifold M2, the hydrogen and condensate water may be discharged through the fifth manifold M5, which is disposed so as to be spaced apart from the second manifold M2 in the diagonal direction. On the other hand, in the case in which hydrogen, which is the reactant gas, is introduced into the first manifold M1, the hydrogen and condensate water may be discharged through the sixth manifold M6, which is disposed so as to be spaced apart from the first manifold M1 in the diagonal direction. Also, in the case in which air containing oxygen is introduced through the second manifold M2, the oxygen and condensate water may be discharged through the fifth manifold M5, which is disposed so as to be spaced apart from the second manifold M2 in the diagonal direction.

Hereinafter, the unit fuel cell 110A of the fuel cell 110 included in the flat fuel cell device 100 according to an embodiment will be described as being configured such that air containing oxygen is introduced through the first manifold M1, such that oxygen, which is the reactant gas, and condensate water are discharged through the sixth manifold M6, such that hydrogen is introduced through the second manifold M2, and such that hydrogen, which is the reactant gas, and condensate water are discharged through the fifth manifold M5. However, the embodiments are not limited thereto. That is, the following description may also apply to a unit fuel cell in which hydrogen is introduced through the first manifold M1, in which hydrogen, which is the reactant gas, and condensate water are discharged through the sixth manifold M6, in which air containing oxygen is introduced through the second manifold M2, and in which oxygen, which is the reactant gas, and condensate water are discharged through the fifth manifold M5.

Hereinafter, as shown in FIGS. 2A and 2B, the unit fuel cell 110A will be described as being configured such that one side thereof (e.g., the first end plate) includes the first, second, fifth, and sixth manifolds M1, M2, M5, and M6 and such that the other side thereof (e.g., the second end plate) includes the third and fourth manifolds M3 and M4.

Accordingly, air containing oxygen and hydrogen, which are supplied from the outside, may respectively pass through the first and second manifolds M1 and M2 of the first end plate, and may then be introduced into the cell stack as reactant gases through the first and second manifolds M1 and M2 of the first and second separators included in each cell, which respectively communicate with the first and second manifolds M1 and M2 of the first end plate.

Also, the reactant gases that have been completely used and condensate water may respectively pass through the fifth and sixth manifolds M5 and M6 of the first and second separators included in each cell, and may then be discharged from the cell stack to the outside through the fifth and sixth manifolds M5 and M6 of the first end plate, which respectively communicate with the fifth and sixth manifolds M5 and M6 of the first and second separators included in each cell.

Hereinafter, the flat fuel cell device 100 according to an embodiment will be described in detail. Although the flat fuel cell device 100 according to the embodiment will be described as including the above-described unit fuel cell 110A, the embodiments are not limited thereto. That is, the following description may be applied without being limited to any specific configuration or type of fuel cell 110 of the flat fuel cell device 100 according to the embodiment.

The flat fuel cell device 100 according to the embodiment may further include, in addition to the above-described fuel cell 110, a junction box (or a high-voltage junction box or a power distribution unit (PDU)), an air-processing unit (or an air supply unit or an air-processing system (APS)), and a hydrogen-processing unit (or a hydrogen supply unit or a fuel-processing system (FPS)).

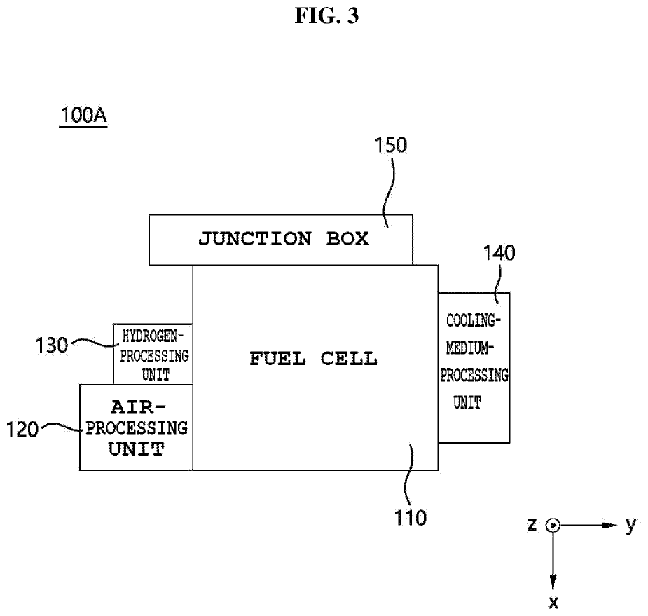

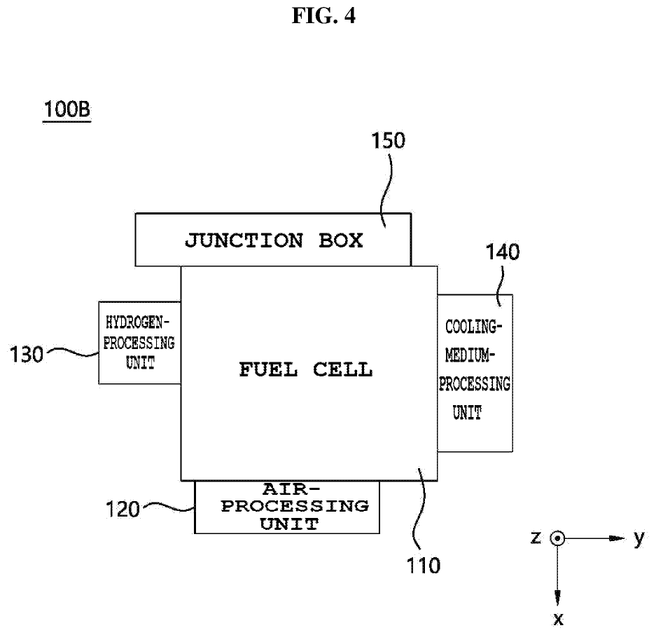

FIG. 3 is a plan view of an embodiment 100A of the flat fuel cell device 100 shown in FIG. 1, and FIG. 4 is a plan view of another embodiment 100B of the flat fuel cell device 100 shown in FIG. 1.

Each of the flat fuel cell devices 100A and 100B shown in FIGS. 3 and 4 may include a fuel cell 110, an air-processing unit 120, a hydrogen-processing unit 130, and a junction box 150.

According to the embodiment, each of the air-processing unit 120, the hydrogen-processing unit 130, and the junction box 150 maybe disposed so as to be contiguous with the fuel cell 110 in the horizontal direction.

According to the embodiment, the fuel cell 110 may have a planar shape that is surrounded by the air-processing unit 120, the hydrogen-processing unit 130, and the junction box 150 in the horizontal direction. In this case, the fuel cell 110, the air-processing unit 120, the hydrogen-processing unit 130, and the junction box 150 maybe disposed so as not to overlap each other in the vertical direction.

The junction box 150 is electrically connected to the fuel cell 110, and serves to distribute the power generated in the cell stack of the fuel cell 110. For example, the junction box 150 may include fuses (not shown) and relays (not shown) to control peripheral auxiliary components (balance-of-plant (BOP)) assisting in the operation of the fuel cell 110.

Also, according to the embodiment, although not shown, the flat fuel cell device 100 according to the embodiment may further include a power controller.

In this case, according to the embodiment, each of the air-processing unit 120, the hydrogen-processing unit 130, the junction box 150, and the power controller may be disposed so as to be contiguous with the fuel cell 110 in the horizontal direction. Alternatively, the power controller may be disposed so as to be spaced apart from the fuel cell 110 in the horizontal direction, rather than being contiguous therewith.

Also, according to the embodiment, the fuel cell 110 may have a planar shape that is surrounded by the air-processing unit 120, the hydrogen-processing unit 130, the junction box 150, and the power controller in the horizontal direction. In this case, the fuel cell 110, the air-processing unit 120, the hydrogen-processing unit 130, the junction box 150, and the power controller may be disposed so as not to overlap each other in the vertical direction.

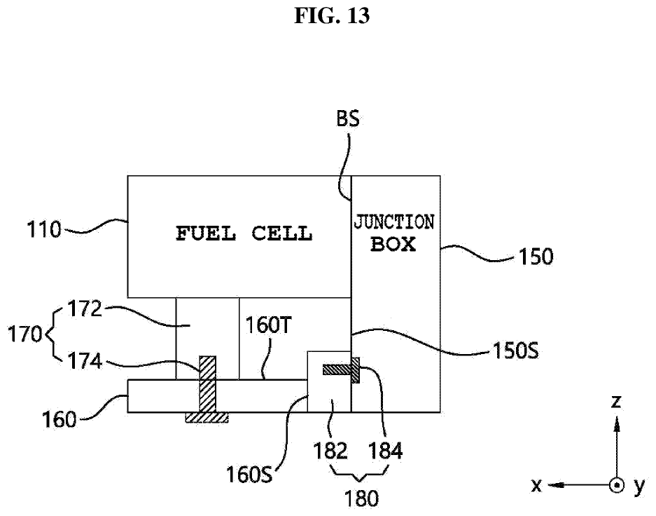

The power controller serves to boost the output voltage of the fuel cell 110. For example, the power controller maybe implemented as a high-voltage boosting-type direct-current (DC)/direct-current (DC) converter (or a fuel-cell DC/DC converter (FDC)), and may be supported by a system frame 160, which will be described later with reference to FIG. 13.

The air-processing unit 120 manages the inflow and outflow of air containing oxygen between the outside and the fuel cell 110. That is, the air-processing unit 120 serves to introduce air containing oxygen into the fuel cell 110 from the outside and to discharge oxygen, which is the reactant gas, and condensate water from the fuel cell 110 to the outside.

The hydrogen-processing unit 130 manages the inflow and outflow of hydrogen to and from the fuel cell 110. That is, the hydrogen-processing unit 130 serves to introduce hydrogen into the fuel cell 110 from the outside and to discharge hydrogen, which is the reactant gas, and condensate water from the fuel cell 110 to the outside.

In addition, each of the flat fuel cell devices 100A and 100B according to the embodiments may further include a cooling-medium-processing unit (or a thermal management unit or a thermal management system (TMS)) 140.

The cooling-medium-processing unit 140 manages the inflow and outflow of the cooling medium to and from the fuel cell 110. That is, the cooling-medium-processing unit 140 serves to introduce the cooling medium into the fuel cell 110 from the outside and to discharge the cooling medium from the fuel cell 110 to the outside.

The aforementioned peripheral auxiliary components may include, for example, at least one of the air-processing unit 120, the hydrogen-processing unit 130, or the cooling-medium-processing unit 140.

According to the embodiment, each of the cooling-medium-processing unit 140, the air-processing unit 120, the hydrogen-processing unit 130, the junction box 150, and the power controller may be disposed so as to be contiguous with the fuel cell 110 in the horizontal direction. Alternatively, the power controller may be disposed so as to be spaced apart from the fuel cell 110 in the horizontal direction, rather than being contiguous therewith.

According to the embodiment, the fuel cell 110 may have a planar shape that is surrounded by the cooling-medium-processing unit 140, the air-processing unit 120, the hydrogen-processing unit 130, the junction box 150, and the power controller in the horizontal direction. In this case, the fuel cell 110, the cooling-medium-processing unit 140, the air-processing unit 120, the hydrogen-processing unit 130, the junction box 150, and the power controller may be disposed so as not to overlap each other in the vertical direction.

According to the embodiment, at least a portion of at least one of the air-processing unit 120 or the hydrogen-processing unit 130 may be disposed in the side area.

For example, a portion of at least one of the air-processing unit 120 or the hydrogen-processing unit 130 may be disposed in the side area, and the remaining portion of at least one of the air-processing unit 120 or the hydrogen-processing unit 130 may be disposed in at least one of the front area or the rear area.

Alternatively, as illustrated in FIG. 3, both the air-processing unit 120 and the hydrogen-processing unit 130 may be disposed in the left area LA of the side area. In this case, at least a portion of the air-processing unit 120 may be disposed farther away from the left side LS of the fuel cell 110 than the hydrogen-processing unit 130.

Alternatively, as illustrated in FIG. 4, the air-processing unit 120 maybe disposed in the front side area FA of the front area, and the hydrogen-processing unit 130 may be disposed in the left area LA of the side area.

Also, the hydrogen-processing unit 130 maybe disposed in at least one of the left area LA, the first left extension area LEA1, or the second left extension area LEA2, and the cooling-medium-processing unit 140 maybe disposed in at least one of the right area RA, the first right extension area REA1, or the second right extension area REA2.

Alternatively, the hydrogen-processing unit 130 maybe disposed in at least one of the right area RA, the first right extension area REA1, or the second right extension area REA2, and the cooling-medium-processing unit 140 may be disposed in at least one of the left area LA, the first left extension area LEA1, or the second left extension area LEA2.

For example, as shown in FIGS. 3 and 4, the hydrogen-processing unit 130 maybe disposed in the left area LA, and the cooling-medium-processing unit 140 may be disposed in the right area RA.

Also, the junction box 150 maybe disposed in the rear area. For example, as illustrated in FIGS. 3 and 4, the junction box 150 maybe disposed over the rear side area BA and the first rear side extension area BEA1 of the rear area.

Hereinafter, the configuration and operation of the air-processing unit 120 according to an embodiment will be described.

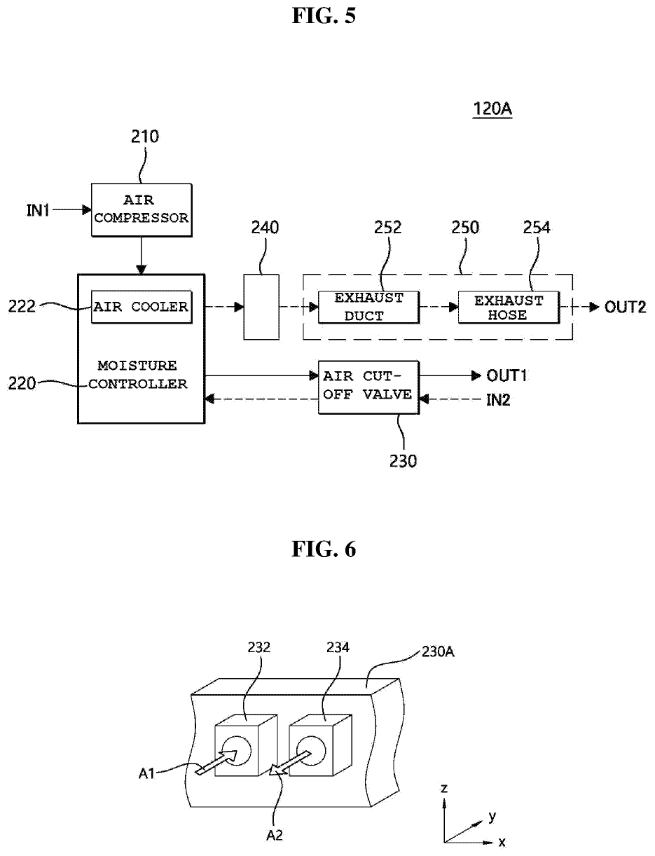

FIG. 5 is a block diagram of an embodiment 120A of the air-processing unit 120. For better understanding, in FIG. 5, a path through which air flows into the fuel cell 110 from the outside is indicated by solid lines, and a path through which oxygen, which is the reactant gas, and condensate water are discharged from the fuel cell 110 to the outside is indicated by dotted lines.

According to the embodiment, the air-processing unit 120A may include an air compressor 210, a moisture controller 220, an air cut-off valve (ACV) 230, an air pressure controller (APC) (or a pneumatic control valve) 240, and a discharge unit 250.

The air compressor 210 suctions air from the outside through an input terminal IN1 and blows the air to the moisture controller 220.

Also, although not shown, in order to supply clean air to the fuel cell 110, an air purifier maybe disposed in the path through which air is supplied to the air compressor 210. The air purifier serves to purify the air received from the outside through the input terminal IN1 and to provide the purified air to the air compressor 210. In this case, the air compressor 210 compresses the air purified by the air purifier and outputs the compressed air to the moisture controller 220.

The moisture controller 220 humidifies the air discharged from the air compressor 210 and provides the humidified air to the air cut-off valve 230. To this end, the moisture controller 220 may include a humidifier (not shown) for humidifying the dry air discharged from the air compressor 210.

In this case, an air cooler 222 may cool the air compressed by the air compressor 210, and the cooled air may be humidified by the moisture controller 220, and may then be provided to the air cut-off valve 230. Although the air cooler 222 is illustrated as being included in the moisture controller 220, the embodiments are not limited thereto. Alternatively, the air cooler 222 may be disposed between the air compressor 210 and the moisture controller 220.

The air cut-off valve 230 provides the air humidified by the moisture controller 220 to the first manifold M1 of the fuel cell 110 through an output terminal OUT1.

In addition, the air cut-off valve 230 receives through an input terminal IN2 oxygen, which is the reactant gas, and condensate water discharged from the sixth manifold M6 of the fuel cell 110, and provides the same to the moisture controller 220.

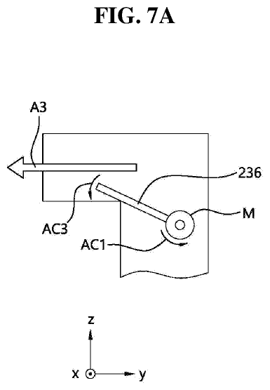

FIG. 6 is a perspective view of an embodiment 230A of the air cut-off valve 230 shown in FIG. 5.

Referring to FIG. 6, the air cut-off valve 230A may include first and second opening/closing portions 232 and 234. The first opening/closing portion 232 receives the humidified air discharged from the moisture controller 220 in the direction of the arrow A1 and selectively discharges the humidified air to the fuel cell 110 in the first direction, which is a horizontal direction.

The second opening/closing portion 234 receives oxygen, which is the wet reactant gas containing moisture, discharged from the fuel cell 110 and selectively discharges the same to the moisture controller 220 in the first direction indicated by the arrow A2, which is a horizontal direction.

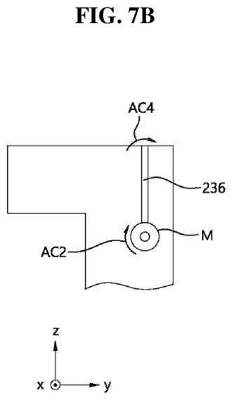

FIGS. 7A and 7B are cross-sectional views for explaining the operation of the air cut-off valve 230A shown in FIG. 6. The opening/closing operation of each of the first and second opening/closing portions 232 and 234 will be described with reference to FIGS. 7A and 7B. FIG. 7A shows the opening operation of each of the first and second opening/closing portions 232 and 234, and FIG. 7B shows the closing operation of each of the first and second opening/closing portions 232 and 234.

Referring to FIG. 7A, when a motor M rotates in the direction of the arrow AC1, an opening/closing plate 236 of the first opening/closing portion 232 moves in the direction of the arrow AC3, whereby the humidified air moves to the fuel cell 110 in the direction of the arrow A3. Also, referring to FIG. 7B, when the motor M rotates in the direction of the arrow AC2, the opening/closing plate 236 of the first opening/closing portion 232 moves in the direction of the arrow AC4, thereby interrupting the provision of the humidified air to the fuel cell 110.

Referring to FIG. 7A, when the motor M rotates in the direction of the arrow AC1, an opening/closing plate 236 of the second opening/closing portion 234 moves in the direction of the arrow AC3, whereby oxygen, which is the reactant gas containing moisture, moves to the moisture controller 220 in the direction of the arrow A3. Also, referring to FIG. 7B, when the motor M rotates in the direction of the arrow AC2, the opening/closing plate 236 of the second opening/closing portion 234 moves in the direction of the arrow AC4, thereby interrupting the provision of oxygen, which is the reactant gas containing moisture, to the moisture controller 220.

Referring again to FIG. 5, the moisture controller 220 dehumidifies oxygen, which is the reactant gas containing moisture, supplied thereto from the fuel cell 110 via the air cut-off valve 230, and discharges the dehumidified oxygen to the air pressure controller 240.

For example, the moisture controller 220 may include a dehumidifier including a plurality of cartridges (or a hollow fiber membrane bundle), which is capable of containing moisture. In this case, the moisture controller 220 may introduce oxygen, which is the reactant gas containing moisture, and condensate water discharged from the fuel cell 110 into a shell side (not shown) between the plurality of hollow fiber membranes, and may supply moisture to the plurality of hollow fiber membranes. Thereafter, the oxygen dehumidified by supplying moisture to the plurality of hollow fiber membranes may be discharged from the moisture controller 220.

The above-described operation of the moisture controller 220 is an example for helping understanding, and the embodiments are not limited to any specific operation or configuration of the moisture controller 220. For example, the humidifier and the dehumidifier described above may be integrated, and the moisture controller 220 may be provided with a path through which dry air to be provided to the fuel cell 110 is humidified and a path through which oxygen discharged from the fuel cell 110 is dehumidified.

The air pressure controller 240 serves to adjust the pressure so that the flat fuel cell device 100 operates at an appropriate operation pressure. For example, the air pressure controller 240 serves to control the pressure of oxygen, which is the reactant gas humidified by the moisture controller 220.

In the case in which the air discharged from the cell stack of the fuel cell 110 moves to the discharge unit 250 without resistance, the time during which the air reacts with hydrogen while remaining in the cell stack of the fuel cell 110 may decrease due to the pressure at which the air compressor 210 supplies air. In order to prevent this problem, the air pressure controller 240 adjusts the degree of opening of the valve included in the air pressure controller 240 according to a load, thereby forming back pressure to be applied to an air terminal in the cell stack. Accordingly, the air supplied to the cell stack is capable of reacting with hydrogen for a sufficient amount of time.

The discharge unit 250 serves to discharge the air discharged from the air pressure controller 240 to the outside through an output terminal OUT2. To this end, the discharge unit 250 may include an exhaust duct 252 and an exhaust hose 254.

The exhaust duct 252 forms a path through which the air output from the air pressure controller 240 passes. The exhaust hose 254 serves to discharge the air passing through the exhaust duct 252 to the outside through the output terminal OUT2.

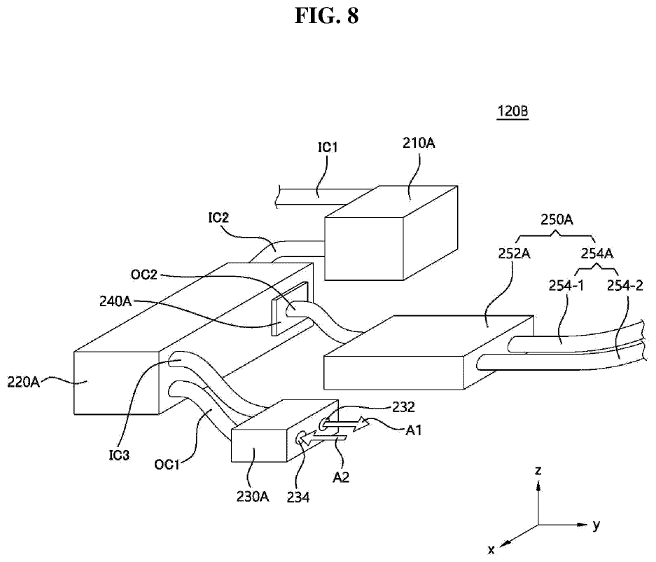

FIG. 8 is a perspective view showing the external appearance of an embodiment 120B of the air-processing unit 120A shown in FIG. 5.

The air-processing unit 120B shown in FIG. 8 may include an air compressor 210A, a moisture controller 220A, an air cut-off valve 230A, an air pressure controller 240A, a discharge unit 250A, and pipes (or hoses) IC1, IC2, IC3, OC1, and OC2. Here, the air compressor 210A, the moisture controller 220A, the air cut-off valve 230A, the air pressure controller 240A, and the discharge unit 250A respectively correspond to embodiments of the air compressor 210, the moisture controller 220, the air cut-off valve 230, the air pressure controller 240, and the discharge unit 250 shown in FIG. 5, and respectively perform the same functions as the air compressor 210, the moisture controller 220, the air cut-off valve 230, the air pressure controller 240, and the discharge unit 250, and thus a duplicate description thereof will be omitted.

Referring to FIG. 6, the humidified air introduced into the first opening/closing portion 232 in the direction of the arrow A1 is supplied to the fuel cell 110. Thus, in FIG. 8, the direction in which the air is discharged from the first opening/closing portion 232 to be provided to the fuel cell 110 is indicated by the arrow A1, which is identical to that in FIG. 6. Also, referring to FIG. 6, oxygen, which is the reactant gas discharged from the fuel cell 110, is discharged through the second opening/closing portion 234 in the direction of the arrow A2. Thus, in FIG. 8, the direction in which the reactant gas discharged from the fuel cell 110 flows into the second opening/closing portion 234 is indicated by the arrow A2, which is identical to that in FIG. 6.

The discharge unit 250A includes an exhaust duct 252A and an exhaust hose 254A. Here, the exhaust duct 252A and the exhaust hose 254A respectively correspond to embodiments of the exhaust duct 252 and the exhaust hose 254 shown in FIG. 5, and respectively perform the same functions as the exhaust duct 252 and the exhaust hose 254, and thus a duplicate description thereof will be omitted.

The exhaust hose 254A may have a multi-pipe structure. For example, as shown in FIG. 8, the exhaust hose 254A may have a double pipe structure including first and second pipes 254-1 and 254-2.

The parts 210A, 220A, 230A, and 252A shown in FIG. 8 may be connected to each other via pipes.

The first to third inlet pipes IC1, IC2, and IC3 may be disposed in a path through which air is introduced into the fuel cell 110 from the outside. For example, the air compressor 210A may introduce air containing oxygen from the outside through the first inlet pipe IC1. The air compressed by the air compressor 210A may be provided to the moisture controller 220A through the second inlet pipe IC2. The air humidified by the moisture controller 220A may be provided to the air cut-off valve 230A through the third inlet pipe IC3.

In addition, the first and second outlet pipes OC1 and OC2 may be disposed together with the discharge unit 250A in a path through which oxygen, which is the reactant gas discharged from the fuel cell 110, is discharged to the outside. Oxygen, which is the reactant gas discharged from the air cut-off valve 230A, may be provided to the moisture controller 220A through the first outlet pipe OC1. Oxygen, which is dehumidified by the moisture controller 220A and is then controlled in pressure by the air pressure controller 240A, and condensate water may be provided to the discharge unit 250A through the second outlet pipe OC2. Although the moisture controller 220A and the air pressure controller 240A are illustrated as being directly connected to each other without a pipe, the embodiments are not limited thereto. That is, according to another embodiment, a separate outlet pipe (not shown) may be disposed between the moisture controller 220A and the air pressure controller 240A. In this case, oxygen, which is the reactant gas discharged from the fuel cell 110 and dehumidified by the moisture controller 220A, may be provided to the air pressure controller 240A through the separate outlet pipe.

Hereinafter, the configuration and operation of the hydrogen-processing unit 130 according to an embodiment will be described.

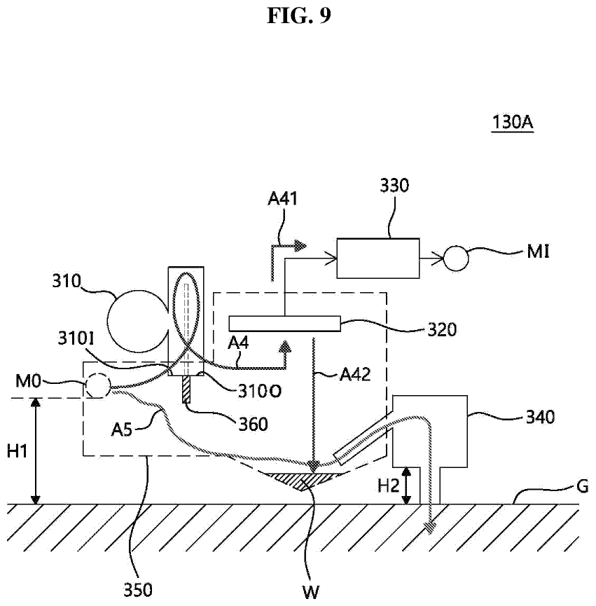

FIG. 9 is a view showing the configuration of an embodiment 130A of the hydrogen-processing unit 130.

The hydrogen-processing unit 130 may include a blower 310, a fluid classifier (or a gas-liquid separator) 320, an ejector 330, and a drain/purge valve 340.

The blower 310 suctions fluids discharged from a hydrogen outflow manifold MO (e.g., the fifth manifold M5) of the fuel cell 110, i.e., hydrogen, which is the reactant gas, and condensate water, through an inlet 310I thereof, and blows the same through an outlet 310O thereof. The aforementioned hydrogen outflow manifold MO is an outlet of the fuel cell 110 through which hydrogen, which is the reactant gas, and condensate water are discharged. The hydrogen outflow manifold MO may be located at a first height H1 from the ground G (or the bottom surface on which the condensate water W is collected).

The fluid classifier 320 separates hydrogen and condensate water from the fluid discharged in the direction of arrow A4 from the blower 310. At this time, the fluid introduced into the blower 310 may circulate inside the blower 310, as indicated by the arrow A4.

The ejector 330 supplies the hydrogen separated from the fluid by the fluid classifier 320 and discharged in the direction of the arrow A41 to a hydrogen inflow manifold MI (e.g., the second manifold M2) of the fuel cell 110, thereby recirculating the hydrogen. However, when the purity of the hydrogen is reduced, the ejector 330 may discharge the hydrogen to the outside to purge the same, rather than recirculating the same to the fuel cell 110.

The drain/purge valve 340 discharges the condensate water W, separated from the fluid by the fluid classifier 320 and discharged in the direction of the arrow A42, and hydrogen, which is the reactant gas flowing out of the hydrogen outflow manifold MO, in the direction of the arrow A5. Here, purging refers to discharging of hydrogen to the atmosphere when the purity of hydrogen, which is the reactant gas discharged from the fuel cell 110, is reduced.

For example, as described above, in order to discharge low-purity hydrogen to the outside, rather than recycling the same, the operation of the blower 310 may be stopped. In this case, the hydrogen discharged from the hydrogen outflow manifold MO may flow to the drain/purge valve 340 in the direction of the arrow A5, rather than being introduced into the blower 310, but the embodiments are not limited thereto.

Also, the drain/purge valve 340 may be connected to the exhaust duct 252 (or 252A) of the air-processing unit 120 (120A or 120B). Accordingly, hydrogen, which is the reactant gas, and condensate water discharged from the fuel cell 110 may be directly discharged to the outside through the exhaust duct 252 (or 252A) and the exhaust hose 254 (or 254A).

At this time, when the condensate water W is collected to a predetermined level or higher therein, the drain/purge valve 340 may discharge the condensate water W to the outside through the exhaust duct 252 (or 252A) and the exhaust hose 254 (or 254A).

The drain/purge valve 340 may be located at a second height H2 from the ground G (or the bottom surface on which the condensate W is collected). According to the embodiment, the hydrogen outflow manifold MO may be located at a higher position than the drain/purge valve 340 from the ground G. That is, the first height H1 may be higher than the second height H2.

The hydrogen-processing unit 130A may further include a partition wall 360. The partition wall 360 serves to separate the inlet 310I and the outlet 310O of the blower 310 from each other. Accordingly, the partition wall 360 may prevent hydrogen and condensate water discharged from the outlet 310O of the blower 310 from being introduced into the inlet 310I of the blower 310. As a result, the partition wall 360 allows fluid to flow in the direction of the arrow A4 shown in FIG. 9.

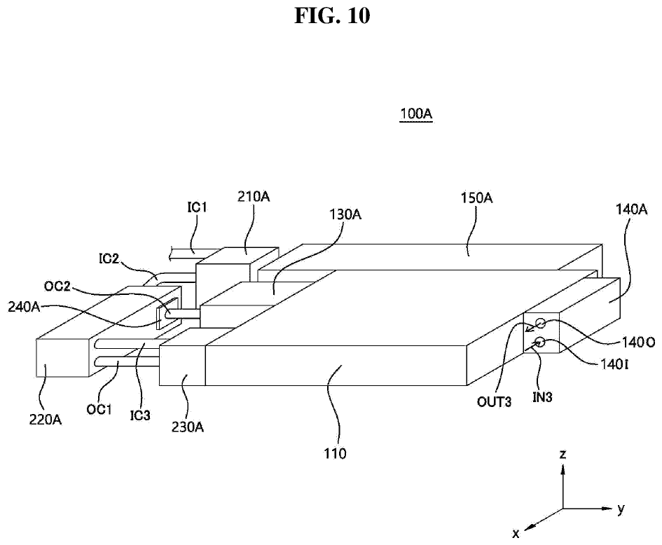

FIG. 10 is a perspective view showing the external appearance of an embodiment of the flat fuel cell device 100A shown in FIG. 3.

Referring to FIG. 10, it can be seen that each of the air-processing unit 120B shown in FIG. 8, the hydrogen-processing unit 130A shown in FIG. 9, the cooling-medium-processing unit 140A, and the junction box 150A maybe disposed so as to be contiguous with the fuel cell 110 in the first and second directions, which are the horizontal directions.

In addition, it can be seen that the flat fuel cell device 100A shown in FIG. 10 has a planar shape in which the air-processing unit 120B, the hydrogen-processing unit 130A, the cooling-medium-processing unit 140A, and the junction box 150A are disposed so as to surround the fuel cell 110 in the horizontal direction. In this case, the air-processing unit 120B, the hydrogen-processing unit 130A, the cooling-medium-processing unit 140A, the junction box 150A, and the fuel cell 110 are disposed so as not to overlap each other in the vertical direction.

The cooling-medium-processing unit 140A and the junction box 150A shown in FIG. 10 respectively correspond to embodiments of the cooling-medium-processing unit 140 and the junction box 150 shown in FIGS. 3 and 4, and respectively perform the same functions as the cooling-medium-processing unit 140 and the junction box 150, and thus a duplicate description thereof will be omitted.

Referring to FIG. 10, the cooling-medium-processing unit 14A may include an inlet 140I and an outlet 140O. A cooling medium to be supplied to the fuel cell 110 may be introduced into the inlet 140I from the outside, and the cooling medium flowing out of the fuel cell 110 may flow (or may be discharged) to the outside through the outlet 140O. As shown in the drawings, the inlet 140I and the outlet 140O may be oriented toward the front area (e.g., the second front side extension area FEA2), but the embodiments are not limited thereto.

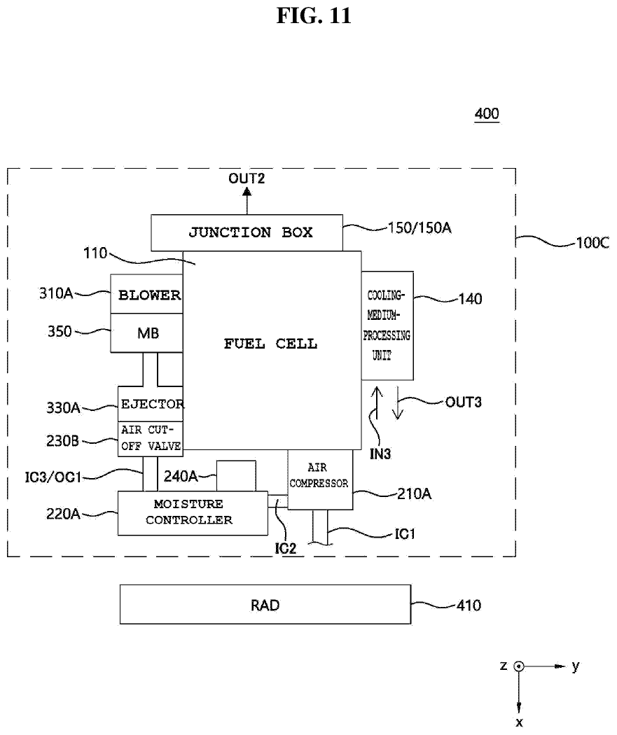

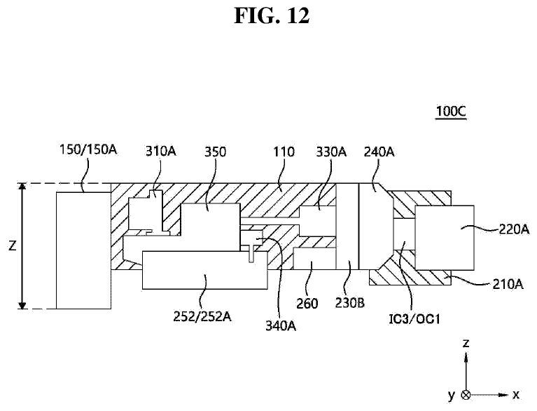

FIG. 11 is a plan view of a fuel cell vehicle 400 including a flat fuel cell device 100C according to still another embodiment, and FIG. 12 is a left-side view of the flat fuel cell device 100C shown in FIG. 11.

Unlike the flat fuel cell devices 100A and 100B shown in FIGS. 3 and 4, the flat fuel cell device 100C shown in FIG. 11 is configured such that the air-processing unit 120 is disposed over the left area LA, the second left extension area LEA2, the front side area FA, and the first front side extension area FEA1. In this case, the air-processing unit 120 may further include an additional manifold 260, as shown in FIG. 12. The additional manifold 260 serves to interconnect the air cut-off valve 230B and the fuel cell 110.

In addition, when the flat fuel cell device 100 is configured as shown in FIG. 4, the air-processing unit 120 may include an additional manifold for supplying air between the outside and the fuel cell 110.

In this case, as shown in FIG. 12, the pipes IC3 and OC1 interconnecting the moisture controller 220A and the air cut-off valve 230B maybe disposed so as to prevent the backflow of fluid.

The air cut-off valve 230B shown in FIGS. 11 and 12 performs the same function as the above-described air cut-off valves 230 and 230A, except that the same is connected to the fuel cell 110 via the additional manifold 260, and thus a duplicate description thereof will be omitted.

The flat fuel cell device 100C shown in FIGS. 11 and 12 is the same as the flat fuel cell device 100A according to the above-described embodiment, except that the area in which the air-processing unit 120 is disposed is different from that in the flat fuel cell device 100A and that the additional manifold 260 is further included. Also, the flat fuel cell device 100C shown in FIGS. 11 and 12 is the same as the flat fuel cell device 100B according to the above-described embodiment, except that the area in which the air-processing unit 120 is disposed is different from that in the flat fuel cell device 100B. Thus, the same parts are denoted by the same reference numerals, and a duplicate description thereof will be omitted.

In addition, the hydrogen-processing unit 140 shown in FIGS. 11 and 12 includes a manifold unit (MB) 350. Here, the manifold unit 350 may be defined as a part shown in FIG. 9, which is connected to the hydrogen outflow manifold MO, the inlet 310I and the outlet 310O of the blower 310, and the drain/purge valve 340, and which includes the fluid classifier 320 and the partition wall 360.

As shown in FIG. 11, when a radiator (RAD) 410 is disposed at the front side of a vehicle 400 including the flat fuel cell device 100C, the grill of the vehicle, which receives air while the vehicle 400 travels, is located close to the first inlet pipe IC1, which is the inlet of the air-processing unit 120, whereby the differential pressure in the air suction line may be improved.

Further, the inlet 140I of the cooling-medium-processing unit 140, into which the cooling medium flows from the outside through an input terminal IN3, and the outlet 140O of the cooling-medium-processing unit 140, through which the cooling medium to be discharged to the outside flows to an output terminal OUT3, are located close to the radiator 410, whereby the differential pressure in the cooling line maybe improved.

FIG. 13 is a right-side view of the flat fuel cell device according to an embodiment.

The right-side view of the flat fuel cell device shown in FIG. 13 may also apply to the flat fuel cell devices 100A, 100B, and 100C according to the embodiments described above.

The flat fuel cell device according to the embodiment may further include a system frame 16o. The fuel cell 110 and the junction box 150 may be mounted to the system frame 160.

The flat fuel cell device according to the embodiment maybe mounted in a vehicle. The vehicle may include a side member (not shown), which corresponds to a vehicle body that forms a side portion of the engine compartment. In this case, the system frame 160 may be mounted to (or supported by or connected to) at least one portion of the side member of the vehicle, and may serve to support at least a portion of each of the fuel cell 110 and the junction box 150.

Irrespective of an example to which the flat fuel cell device is applied, the system frame 160 may support the fuel cell 110 and the junction box 150.

In addition, the flat fuel cell device may include a coupling unit for coupling at least one of the fuel cell 110, the air-processing unit 120, the hydrogen-processing unit 130, the cooling-medium-processing unit 140, the junction box 150, or the power controller to the system frame 160.

For example, the coupling unit may include first and second coupling units 170 and 180.

The first coupling unit 170 may serve to couple the lower portion of the fuel cell 110 to the system frame 160. To this end, for example, the first coupling unit 170 may include a first mounting part 172 and a first fastening part 174.

The first mounting part 172 may be disposed between the lower portion of the fuel cell 110 and the upper surface 160T of the system frame 160. For example, the first mounting part 172 may have one end coupled to the fuel cell 110 and the other end coupled to the system frame 160. One end of the first mounting part 172 may be supported by (or fastened to or coupled to) the fuel cell 110 at a plurality of points (e.g., four points).

The first fastening part 174 may couple the system frame 160 to the first mounting part 172. For example, the first fastening part 174 may be implemented as a bolt that penetrates the system frame 160 and is then screwed to the first mounting part 172.

The second coupling unit 180 may serve to couple a portion protruding and extending from a side portion of the junction box 150 in the second direction, which is the vertical direction, to the system frame 160. To this end, for example, the second coupling unit 180 may include a second mounting part 182 and a second fastening part 184.

The second mounting part 182 may be disposed between a side surface 150S of the protruding portion of the junction box 150 and a side surface 160S of the system frame 160, and the second fastening part 184 may couple the junction box 150 to the second mounting part 182. For example, the second fastening part 184 may be implemented as a bolt that is screwed to the second mounting part 182 through the junction box 150.

If the second mounting part 182 is disposed between the rear side BS of the fuel cell 110 and the junction box 150, a high-voltage contact maybe unstable. According to the embodiment, in order to solve this instability, the second mounting part 182 is disposed between the extended side surface 150S of the junction box 150 and the side surface 160S of the system frame 160.

Hereinafter, a fuel cell device according to a comparative example and the flat fuel cell device according to an embodiment will be described with reference to the accompanying drawings.

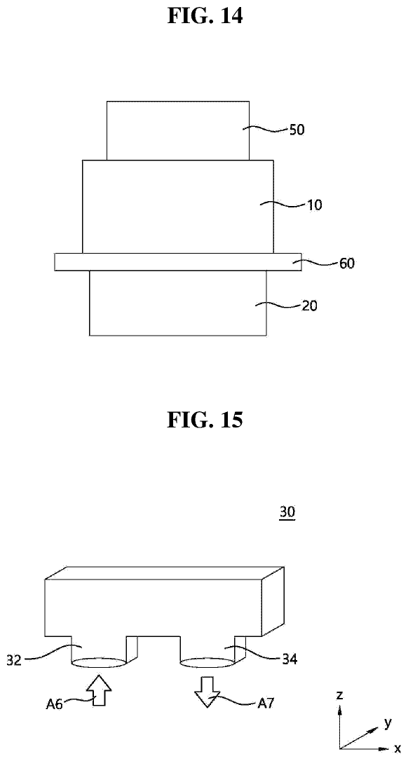

FIG. 14 is a schematic cross-sectional view of a fuel cell device according to a comparative example. The fuel cell device according to the comparative example may include a fuel cell 10, an air-processing unit 20, a junction box 50, and a system frame 60. The fuel cell 10, the air-processing unit 20, the junction box 50, and the system frame 60 may respectively perform the same functions as the fuel cell 110, the air-processing unit 120, the junction box 150, and the system frame 160 according to the embodiment.

In the fuel cell device according to the comparative example, the junction box 50 and driving components (BOP) are disposed so as not to be contiguous with the fuel cell 10 in the horizontal direction. For example, as shown in FIG. 14, the air-processing unit 20 and the junction box 50 are disposed so as not to be contiguous with the fuel cell 10 in the horizontal direction but to overlap the fuel cell 10 in the vertical direction.

In contrast, the flat fuel cell device 100 (100A, 100B, or 100C) according to the embodiment is configured such that the air-processing unit 120 (120A or 120B), the hydrogen-processing unit 130 (or 130A), the junction box 150 (or 150A), and the cooling-medium-processing unit 140 (or 140A) are disposed so as not to overlap the fuel cell 110 in the vertical direction but to be contiguous with the fuel cell 110 only in the horizontal direction.

In addition, the flat fuel cell device 100 (100A, 100B, or 100C) according to the embodiment has a planar shape in which the air-processing unit 120 (120A or 120B), the hydrogen-processing unit 130 (or 130A), the junction box 150 (or 150A), and the cooling-medium-processing unit 140 (or 14A) surround the fuel cell 110 in the horizontal direction, rather than overlapping the fuel cell 110 in the vertical direction.

Accordingly, in the flat fuel cell device 100 (100A, 100B, or 100C) according to the embodiment, the fuel cell 110, the air-processing unit 120 (120A or 120B), the hydrogen-processing unit 130 (or 130A), the junction box 150 (or 150A), and the cooling-medium-processing unit 140 (or 14A) maybe the same height. As a result, the flat fuel cell device 100 (100A, 100B, or 100C) according to the embodiment may have a lower height (or a smaller thickness) than the fuel cell device according to the comparative example.

For example, the flat fuel cell device 100 (100A, 100B, or 100C) according to the embodiment may have a height of 250 mm or lower (e.g., “Z” shown in FIG. 12), but the embodiments are not limited thereto. Due to the low height, the flat fuel cell device 100 (100A, 100B, or 100C) according to the embodiment may be applied to a greater variety of products than the fuel cell device according to the comparative example. For example, the flat fuel cell device 100 (100A, 100B, or 100C) according to the embodiment may be increasingly used in various products, such as trams, aircraft, drones, and electric vehicles.

Further, when used in a vehicle, the fuel cell device according to the comparative example needs to be mounted in the engine compartment of the vehicle. In contrast, the flat fuel cell device 100 (100A, 100B, or 100C) according to the embodiment may be disposed in the engine compartment, or may alternatively be disposed on the underbody or in the trunk of the vehicle thanks to the relatively low height thereof, thereby enabling efficient utilization of the space in the vehicle.

Furthermore, since the flat fuel cell device 100 (100A, 100B, or 100C) according to the embodiment is configured such that the air-processing unit 120 (120A or 120B), the hydrogen-processing unit 130 (or 130A), the junction box 150 (or 150A), and the cooling-medium-processing unit 140 (or 14A) are disposed so as to be contiguous with the fuel cell 110 only in the horizontal direction, it is possible to minimize the amount of empty space between the fuel cell 110 and the above components 120, 130, 140, and 150.

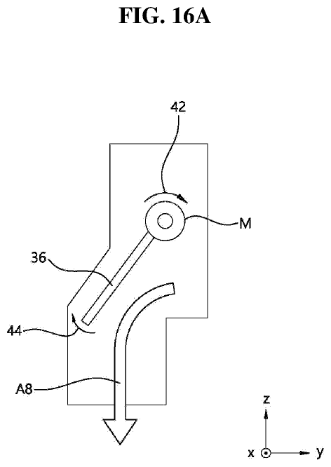

FIG. 15 is a perspective view of an air cut-off valve 30 included in the air-processing unit 20 according to the comparative example. The air cut-off valve 30 shown in FIG. 15 may perform the same function as the air cut-off valve 230A shown in FIG. 6.

Referring to FIG. 15, the air cut-off valve 30 may include first and second opening/closing portions 32 and 34. In the case in which the components of the fuel cell device according to the comparative example are stacked in the vertical direction, as shown in FIG. 14, the first opening/closing portion 32 introduces air discharged from a humidifier (not shown), which functions as the moisture controller 220 of the embodiment, in the third direction A6, which is the vertical direction, and selectively discharges the air to the fuel cell 10.

The second opening/closing portion 34 introduces oxygen, which is a reactant gas discharged from the fuel cell 10, and selectively discharges the oxygen to the humidifier in the third direction A7, which is the vertical direction.

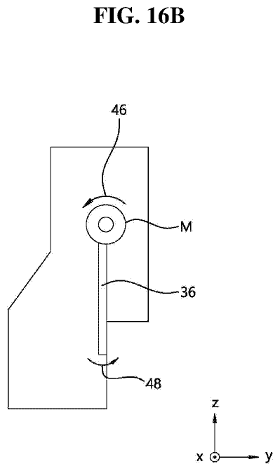

FIGS. 16A and 16B are cross-sectional views for explaining the operation of the air cut-off valve 30 shown in FIG. 15. The opening/closing operation of the first and second opening/closing portions 32 and 34 will now be described with reference to FIGS. 16A and 16B.

Referring to FIG. 16A, when a motor M rotates in the direction of the arrow 42, an opening/closing plate 36 of the first opening/closing portion 32 moves in the direction of the arrow 44, whereby humidified air moves to the fuel cell 10 in the direction of the arrow A8. Alternatively, referring to FIG. 16B, when the motor M rotates in the direction of the arrow 46, the opening/closing plate 36 of the first opening/closing portion 32 moves in the direction of the arrow 48, thereby interrupting the provision of the humidified air to the fuel cell 10.

Referring to FIG. 16A, when the motor M rotates in the direction of the arrow 42, an opening/closing plate 36 of the second opening/closing portion 34 moves in the direction of the arrow 44, whereby oxygen, which is a reactant gas, moves to the humidifier in the direction of the arrow A8. Alternatively, referring to FIG. 16B, when the motor M rotates in the direction of the arrow 46, the opening/closing plate 36 of the second opening/closing portion 34 moves in the direction of the arrow 48, thereby interrupting the provision of oxygen, which is the reactant gas, to the humidifier.

As described above, in the case of the comparative example, the bypass flow path of the air cut-off valve 30 is connected to the humidifier in the vertical direction. Therefore, as shown in FIGS. 16A and 16B, the rotational center of the motor M is located above the inlet of the first opening/closing portion 32 and the outlet of the second opening/closing portion 34. Thus, when the opening/closing plate 36 is opened in order to allow the inflow/outflow of fluid, the fluid may flow in the vertical direction.

In contrast, in the case of the embodiment, since the air-processing unit 120 is disposed so as to be contiguous with the fuel cell 110 in the horizontal direction, it is impossible to use the air cut-off valve 30 of the air-processing unit 20 according to the comparative example shown in FIG. 15. The reason for this is that the embodiment is configured such that the bypass flow path of the air cut-off valve 230 (or 230A) is connected to the moisture controller 220 in the first direction, which is the horizontal direction. Therefore, in the case of the embodiment, as shown in FIGS. 7A and 7B, the rotational center of the motor M is located below the inlet of the first opening/closing portion 232 and the outlet of the second opening/closing portion 234. In this way, the air cut-off valve 230A is configured such that, when the opening/closing plate 136 is opened in order to allow the inflow/outflow of fluid, the fluid flows in the horizontal direction.

Further, in the case of the embodiment, since the air-processing unit 120 and the hydrogen-processing unit 130 are disposed so as to be contiguous with the fuel cell 110 in the horizontal direction, differential pressure maybe reduced compared to the case of the comparative example shown in FIG. 14. Therefore, according to the embodiment, as shown in FIG. 8, the exhaust hose 254A is formed to have a double pipe structure including first and second pipes 254-1 and 254-2, thereby enabling fluid discharge while overcoming the limitation due to low differential pressure.

Also, according to the hydrogen purge method of the fuel cell device of the comparative example, the hydrogen discharged from the fuel cell 10 is discharged to the atmosphere through the humidifier. According to this hydrogen purge method, condensate water is collected in the outlet formed at the side of the air electrode (or cathode (Ca)) of the cell stack during operation of the device, which increases pressure during purging of hydrogen, leading to backflow of air and resultant reverse voltage. Further, when air is supplied to the stack at a low flow rate, hydrogen flows back to the inlet formed at the side of the air electrode (Ca), which causes a cell omission phenomenon, leading to changes in stack voltage and resultant deterioration in operational stability. Furthermore, when air containing oxygen is supplied to the cell stack, a portion of condensate water in the air electrode is supplied together therewith and blocks a portion of the reacting part, whereby required output is not generated. That is, a flooding phenomenon may occur.

In contrast, in the case of the flat fuel cell device according to the embodiment, which is configured as shown in FIG. 9, hydrogen flowing out of the hydrogen outflow manifold MO is directly discharged to the atmosphere through the drain/purge valve 340, the exhaust duct 252, and the exhaust hose 254. Accordingly, the fundamental cause of backflow between the air electrode (Ca) and the hydrogen electrode (An) is eliminated, thus securing robustness of the device and preventing a drop in cell voltage. As a result, output stability is improved.

In addition, in the embodiment, since the hydrogen-processing unit 130 is disposed so as to be contiguous with the fuel cell 110 in the horizontal direction, condensate water flowing out of the hydrogen outflow manifold MO of the fuel cell 110 may flow back therein. However, as shown in FIG. 9, this backflow is prevented by setting the second height H2 to be lower than the first height Hi.

The fuel cell device of the comparative example has few height constraints, and is thus sufficiently high to separate gas and liquid. In contrast, according to the embodiment, since the hydrogen-processing unit 130 is disposed so as to be contiguous with the fuel cell 110 in the horizontal direction, the embodiment is not as high as the comparative example. In order to address this problem, the hydrogen-processing unit 130 according to the embodiment includes the blower 310 and the fluid classifier 320, thereby effectively separating hydrogen and condensate water and recirculating the hydrogen.

As described above, the flat fuel cell device 100 (100A, 100B, or 100C) according to the embodiment is structured so as to overcome various limitations that may be caused by the configuration in which the air-processing unit 120 (120A or 120B), the hydrogen-processing unit 130 (or 130A), the cooling-medium-processing unit 140 (or 140A), and the junction box 150 (or 150A) are disposed so as to be contiguous with the fuel cell 110 in the horizontal direction.

As is apparent from the above description, since the flat fuel cell device according to the embodiment has a low height (or small thickness), the same may be used in a thin product. Also, when used in a vehicle, the space in the vehicle may be efficiently utilized, and the amount of empty space between the fuel cell and each of the junction box and peripheral auxiliary components may be minimized. Further, the flat fuel cell device according to the embodiment may exhibit high robustness and improved output stability by preventing a drop in cell voltage, and may overcome various limitations resulting from the low height thereof.

However, the effects achievable through embodiments of the disclosure are not limited to the above-mentioned effects, and other effects not mentioned herein will be clearly understood by those skilled in the art from the above description.

The above-described various embodiments may be combined with each other without departing from the scope of the present disclosure unless they are incompatible with each other.

In addition, for any element or process that is not described in detail in any of the various embodiments, reference maybe made to the description of an element or a process having the same reference numeral in another embodiment, unless otherwise specified.

While the present disclosure has been particularly shown and described with reference to exemplary embodiments thereof, these embodiments are only proposed for illustrative purposes, and do not restrict the present disclosure, and it will be apparent to those skilled in the art that various changes in form and detail may be made without departing from the essential characteristics of the embodiments set forth herein. For example, respective configurations set forth in the embodiments maybe modified and applied. Further, differences in such modifications and applications should be construed as falling within the scope of the present disclosure as defined by the appended claims.

What is claimed is:

1. A flat fuel cell device comprising:
a fuel cell comprising a cell stack in which a plurality of unit cells is stacked;
a junction box electrically connected to the fuel cell;
an air-processing device configured to manage inflow and outflow of air containing oxygen between an outside and the fuel cell; and
a hydrogen-processing device configured to manage inflow and outflow of hydrogen to and from the fuel cell; and
wherein each of the junction box, the air-processing device, and the hydrogen-processing device is disposed so as to be contiguous with the fuel cell in a horizontal direction.

2. The flat fuel cell device according to claim 1, further comprising a cooling-medium-processing device configured to manage inflow and outflow of a cooling medium to and from the fuel cell, the cooling-medium-processing device being disposed so as to be contiguous with the fuel cell in the horizontal direction.

3. The flat fuel cell device according to claim 2, wherein a portion of the hydrogen-processing device or a portion of the air-processing device is disposed in a side area, the side area comprising at least one of:
a right area overlapping a right side of the fuel cell so as to be contiguous therewith in a first direction, the first direction being a first horizontal direction;
a left area overlapping a left side of the fuel cell so as to be contiguous therewith in the first direction;
a right extension area extending from the right area in a second direction, the second direction being a second horizontal direction, the second direction intersecting the first direction; or
a left extension area extending from the left area in the second direction.

4. The flat fuel cell device according to claim 3, wherein:
the hydrogen-processing device is disposed in the right area, the right extension area, or both the right area and the right extension area; and
the cooling-medium-processing device is disposed in the left area, the left extension area, or both the left area and the left extension area.

5. The flat fuel cell device according to claim 3, wherein:
the hydrogen-processing device is disposed in the left area, the left extension area, or both the left area and the left extension area; and
the cooling-medium-processing device is disposed in the right area, the right extension area, or both the right area and the right extension area.

6. The flat fuel cell device according to claim 2, wherein the junction box is disposed in a rear area, the rear area comprising at least one of:
a rear side area overlapping a rear side of the fuel cell so as to be contiguous therewith in a first direction, the first direction being a first horizontal direction; or
a rear extension area extending from the rear side area in a second direction, the second direction being a second horizontal direction and intersecting the first direction.

7. The flat fuel cell device according to claim 2, wherein the air-processing device comprises:
an air compressor configured to suction air from the outside and to discharge the air;
a moisture controller configured to humidify the air discharged from the air compressor, to discharge the humidified air, to dehumidify oxygen as a reactant gas discharged from the fuel cell, and to discharge the dehumidified oxygen;
an air cut-off valve configured to provide the humidified air to the fuel cell and to provide the oxygen as the reactant gas discharged from the fuel cell to the moisture controller; and
a discharge device configured to discharge the oxygen as the reactant gas passing through the moisture controller to the outside.

8. The flat fuel cell device according to claim 7, wherein the air-processing device is disposed in a front area, the front area comprising at least one of:
a front side area overlapping a front side of the fuel cell so as to be contiguous therewith in a first direction, the first direction being a first horizontal direction; or
a front extension area extending from the front side area in a second direction, the second direction being a second horizontal direction, the second direction intersecting the first direction, and the second direction being a direction in which the plurality of unit cells is stacked.

9. The flat fuel cell device according to claim 8, wherein the air-processing device further comprises an additional manifold interconnecting the air cut-off valve and the fuel cell.

10. The flat fuel cell device according to claim 8, wherein the cooling-medium-processing device comprises:
an inlet into which the cooling medium is introduced; and
an outlet from which the cooling medium is discharged, wherein the inlet and the outlet are oriented toward the front area.

11. The flat fuel cell device according to claim 7, wherein the air cut-off valve comprises:
a first opening/closing portion configured to selectively discharge the air discharged from the moisture controller to the fuel cell in a first horizontal direction; and
a second opening/closing portion configured to selectively discharge the oxygen as the reactant gas discharged from the fuel cell to the moisture controller in a second horizontal direction.

12. The flat fuel cell device according to claim 7, wherein the discharge device comprises:
an exhaust duct defining a path through which the reactant gas output from the moisture controller passes; and
an exhaust hose configured to discharge the reactant gas passing through the exhaust duct to the outside.

13. The flat fuel cell device according to claim 12, wherein the exhaust hose has a multi-pipe structure.

14. The flat fuel cell device according to claim 12, wherein the hydrogen-processing device comprises:
a blower configured to suction and discharge hydrogen as a reactant gas and condensate water;
a fluid classifier configured to separate the hydrogen and the condensate water discharged from the blower;
an ejector configured to supply the hydrogen separated by the fluid classifier to the fuel cell; and
a drain/purge valve connected to the exhaust duct, the drain/purge valve being configured to discharge the condensate water and the hydrogen as the reactant gas separated by the fluid classifier.

15. The flat fuel cell device according to claim 14, wherein the hydrogen-processing device further comprises a partition wall configured to separate an inlet and an outlet of the blower from each other.

16. The flat fuel cell device according to claim 14, wherein an outlet of the fuel cell, via which hydrogen as the reactant gas is discharged, is located at a higher position than the drain/purge valve from a ground.

17. The flat fuel cell device according to claim 1, further comprising a system frame to which the fuel cell and the junction box are mounted.

18. A flat fuel cell device comprising:
a fuel cell comprising a cell stack in which a plurality of unit cells is stacked;
a junction box electrically connected to the fuel cell;
an air-processing device configured to manage inflow and outflow of air containing oxygen between an outside and the fuel cell; and
a hydrogen-processing device configured to manage inflow and outflow of hydrogen to and from the fuel cell; and
wherein the fuel cell has a planar shape that is surrounded by the junction box, the air-processing device, and the hydrogen-processing device in a horizontal direction.

19. A flat fuel cell device comprising:
a fuel cell comprising a cell stack in which a plurality of unit cells is stacked;
a junction box electrically connected to the fuel cell;
an air-processing device configured to manage inflow and outflow of air containing oxygen between an outside and the fuel cell;
a hydrogen-processing device configured to manage inflow and outflow of hydrogen to and from the fuel cell; and
a cooling-medium-processing device configured to manage inflow and outflow of a cooling medium to and from the fuel cell;
wherein the fuel cell is surrounded by the junction box, the air-processing device, the hydrogen-processing device, and the cooling-medium-processing device in a horizontal direction; and
wherein the fuel cell, the junction box, the air-processing device, the hydrogen-processing device, and the cooling-medium-processing device do not overlap each other in a vertical direction.

20. The flat fuel cell device according to claim 19, wherein a portion of the hydrogen-processing device or a portion of the air-processing device is disposed in a side area, the side area comprising at least one of:
a right area overlapping a right side of the fuel cell so as to be contiguous therewith in a first direction, the first direction being a first horizontal direction;
a left area overlapping a left side of the fuel cell so as to be contiguous therewith in the first direction;
a right extension area extending from the right area in a second direction, the second direction being a second horizontal direction, the second direction intersecting the first direction; or
a left extension area extending from the left area in the second direction.
